(19) United States
(12) Patent Application Publication
(10) Pub. No.: US 2001/0037971 A1
(43) Pub. Date: Nov. 8, 2001

(54) OIL FILTER ADAPTER

(75) Inventor: GARY P. BERGERON, WINSTED, CT (US)

Correspondence Address: MCCORMICK PAULDING & HUBER LLP, CITY PLACEII, 185 ASYLUM STREET, HARTFORD, CT, 061034102

(73) Assignee: GARY P. BERGERON

(21) Appl. No.: 09/330,421

(22) Filed: May 28, 1999

(51) Int. Cl. B01D 27/00

(52) U.S. Cl. 210/443

(57) ABSTRACT

An adapter for use with a cover from a conventional fuel oil, diesel oil filter etc. in converting the same to accommodate a standard “spin-on” automotive filter, the cover being of the type which is inlet and discharge ports in an inner chamber defined within a depending annular wall which communicates with the discharge port which opens downwardly. An outer annular chamber around the inner chamber communicates with the inlet port and also opens downwardly. A small substantially vertical through opening for attachment of the cover to the housing is also provided. The adapter has a threaded opening at an upper end portion for engagement with an attachment bolt entered in the through opening in the cover and a sealing shoulder engages a lower end portion of the chamber defining wall in the cover to fix the adapter in position. The outer periphery of the sealing shoulder takes a hex nut configuration and a lower portion of the adapter is threaded externally for ready attachment of a “spin-on” automotive type filter.

### BACKGROUND OF THE INVENTION

A conventional fuel oil or diesel oil filter employs a canister or housing which opens upwardly and which contains a replaceable filter element. A cover is provided to retain the element in position and a rubber gasket seals the canister at the junction of the canister and cover. When a service person replaces a filter element, the canister and cover must be disassembled, the used filter element removed from the canister and discarded, and the canister must then be thoroughly cleaned prior to reassembly with a new filter element and gasket. This procedure is tedious, time-consuming and often results in dripping of oil on the floor or other surfaces.

It is the general object of the present invention to provide an adapter for use with a cover from a conventional fuel oil, diesel oil filter etc. in converting the same to accommodate a standard “spin-on” automotive filter, the conversion being conveniently accomplished without removing or disconnecting existing fuel lines from the cover of the old filter, which remains in place and forms part of the new filter.

### SUMMARY OF THE INVENTION

In fulfillment of the foregoing object and in accordance with the present invention, an adapter is provided for use with a cover from a conventional fuel oil, diesel oil filter etc. and serves to convert the same (in situ) to accommodate a standard “spin-on” automotive filter. Covers under consideration have inlet and discharge ports and an inner chamber defined within a depending annular wall which communicates with one of the ports and which opens downwardly. An outer annular chamber disposed around the inner chamber communicates with the other of said ports and also opens downwardly. A small substantially vertical through opening for attachment of the cover to the filter housing is also provided.

The adapter comprises upper and lower portions respectively for assembly with the cover and with a “spin-on” automotive filter. The upper portion of the adapter has at least one opening in communication with the inner chamber of the cover with the adapter and cover in assembled relationship. The upper portion of the filter also has a radial sealing surface engageable with a lower end portion of the annular wall in the cover when the adapter and cover are assembled. A lower portion of the adapter projects downwardly below the sealing surface and is threaded externally for ready engagement with a standard “spin-on” automotive filter. A second opening in the downwardly projecting portion communicates with the aforesaid at least one opening which communicates with the inner cover chamber as aforesaid. The second opening also communicates with a central portion of a “spin-on” automotive filter when the latter is assembled with and depends from the threaded lower portion of the adapter. When a cover, adapter and “spin-on” filter are assembled, communication is also established between the outer chamber in the cover and an annular outer portion of the “spin-on” filter disposed therebeneath and about its aforesaid central portion. In assembling the cover, adapter and filter, a small upwardly open substantially vertical threaded attachment opening in the upper portion of the adapter is employed. A threaded attachment element entered downwardly through the aforementioned cover attachment opening is threadedly engaged with the attachment opening in the adapter in fixing the cover and the adapter in assembled relationship.

In addition to the foregoing, the adapter automatically seals the aforesaid inner chamber in the cover when it is assembled with the cover. That is, the radial sealing surface on the adapter engages a lower edge surface of the depending annular wall in the cover in the course of assembly of the cover and adapter. Obviously, a separate seal may be provided between the surface and the lower edge of the depending annular wall. It is the presently preferred practice, however, to provide at least an annular sealing shoulder on the adapter which is formed of a relatively soft metal so as to provide an efficient metal-to-metal seal with the lower edge of the annular cover wall. It is presently preferred that the entire adapter be formed of aluminum.

Further in accordance with the presently preferred practice, the sealing surface takes the form of an annular sealing shoulder which is enlarged radially and has a non-circular peripheral surface for engagement by a tool in assembling and disassembling the adapter and cover. Preferably the peripheral surface of the sealing shoulder takes the form of a conventional hex nut.

Still further in accordance with the presently preferred form of the invention, a part of the adapter upper portion projects upwardly beyond the sealing shoulder and into the inner chamber of the cover with at least one opening in communication with the chamber. When the projecting upper portion of the adapter has a radial top surface with a threaded vertical attachment opening for entry of the aforesaid attachment element, at least one radial or transverse bore is provided in the upper portion of the adapter beneath the threaded portion of the opening. Preferably, the adapter takes a cylindrical configuration with an axial through bore which opens downwardly in communication with a central portion of a “spin-on” filter and the transverse bore forms a pair of oppositely directed radial openings or ports for communication between the axial bore in the adapter and the inner chamber of the cover. The upper portion of the bore is threaded for engagement with the attachment element.

### BRIEF DESCRIPTION OF THE DRAWINGS

FIG. 1 is an exploded perspective view of a prior art fuel oil or diesel oil filter;

FIG. 2 is an exploded perspective view of the cover of the filter of FIG. 1, the adapter of the present invention, and a “spin-on” automotive filter; and

FIG. 3 is a side view of the oil filter adapter of the present invention.

### DESCRIPTION OF THE PREFERRED EMBODIMENT

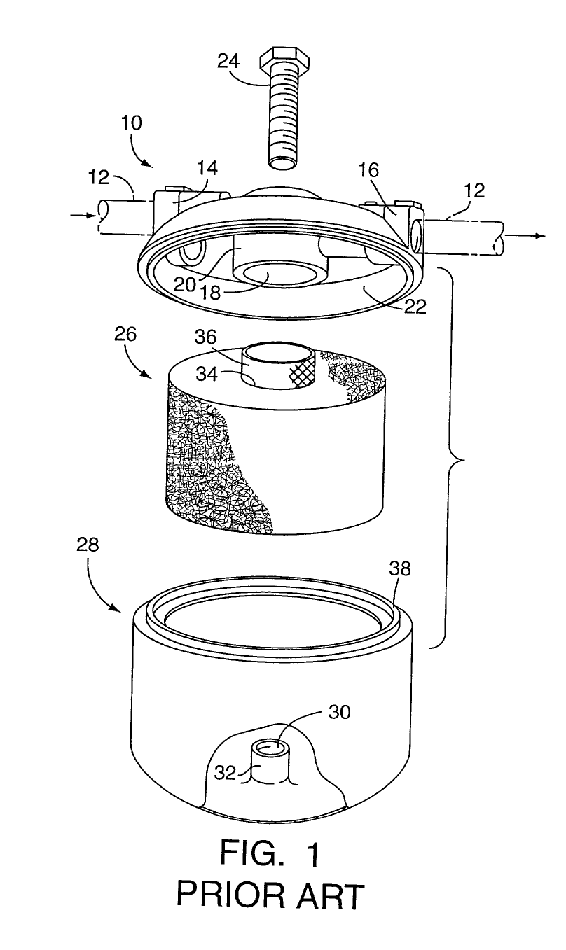

Referring particularly to the prior art oil filter of FIG. 1 which is of a conventional fuel oil, diesel oil etc. design, it will be observed that the filter cover, indicated generally at 10, is connected in a fuel oil supply line 12 partially shown, and has inlet and outlet ports 14 and 16. An inner chamber 18 is defined within a depending annular wall 20 and is in communication with the outlet port 16. An annular outer chamber 22 is disposed about the inner chamber 18 and is in communication with the inlet port 14. Elongated attachment bolt 24 extends through a suitable opening in the cover 10 downwardly within and through a filter element or cartridge 26 and a canister 28 for entry into a threaded opening 30 in an upstanding boss 32 formed on a bottom wall of the canister.

The filter 26 is usually of a compacted felt type with the oil flowing from the annular chamber 22 downwardly and then radially inwardly to a central opening 34 defined therein. A tubular screen 36 may be provided as a liner for the central opening 34 and may have an upwardly projecting upper end portion as shown for entry into the inner cover chamber 18.

The housing or canister 28 is generally cylindrical when the cover and filter take a cylindrical configuration and is closed at the bottom and open upwardly. As mentioned, the upstanding boss 32 defines a small threaded opening 30 which opens upwardly for engagement with the lower end portion of the bolt 24. At its upper end portion the canister or housing is provided with an annular sealing gasket 38 which is usually replaced when the filter element or cartridge 26 is replaced. A small gasket may also be provided under the head of the bolt 24 and in engagement with the top surface of the cover 10.

As mentioned, replacement of the filter element or cartridge 26 is a tedious, time consuming and often messy operation with oil sometimes dripping from the used filter element as it is removed from the canister. Swabbing or otherwise cleaning dirty oil from the bottom of the canister is also a tedious and often dirty operation for the service person. Finally, the removal of the long bolt initially, the disassembly of the cover, filter and canister, and the reassembly thereof is time consuming with difficulty often occurring in reengaging of the lower end portion of the bolt with the remote threaded opening 30 in the boss 32.

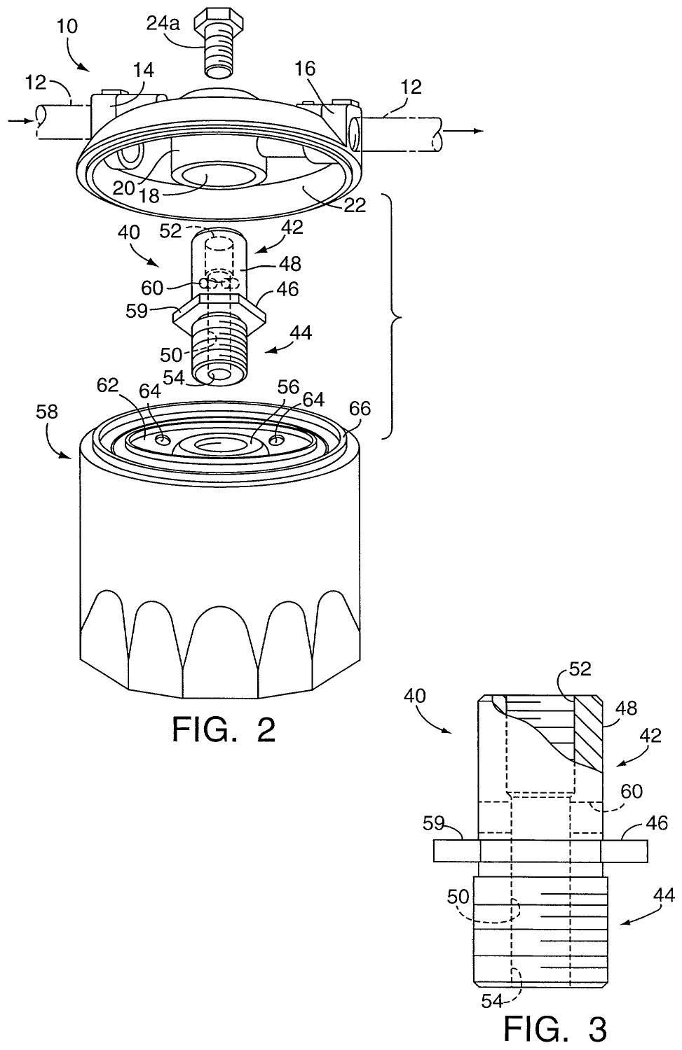

Referring now to FIG. 2, the cover 10 is again shown and the illustration thereof is in all respects identical with the cover 10 of FIG. 1 except for the provision of bolt 24a. The bolt 24a may be identical with the bolt 24 of FIG. 1 except for the length thereof, the former bolt being substantially shorter than the latter for a reason to be set forth hereinbelow.

An adapter indicated generally at 40, and constructed in accordance with the present invention includes upper and lower portions 42 and 44. Upper portion 42 may comprise an annular sealing surface or shoulder 46 only but preferably also includes upwardly projecting cylindrical member 48. When the adapter does not include the upwardly projecting cylindrical member 48 the upper portion 42 of the adapter may terminate at the sealing surface or shoulder 46 as will be explained hereinbelow.

When the cylindrical upwardly projecting member 48 is included, an axial through bore 50 is preferably provided, as shown in FIG. 3, and has upper and lower openings 52, 54. The opening 52 has a threaded portion of the bore which extends downwardly therefrom with the threads adapted to engage the threads of the bolt 24a. The opening 54 provides for downward communication with a central portion 56 of a “spin-on” type automotive filter 58. As best shown in FIG. 3 communication from the opening 54 and through the bore 50 to the inner chamber 18 of the cover is provided by a small transverse or radial bore 60 which communicates with the bore 50 and opens at each end to the chamber 18. Thus, communication for the free flow of oil is provided between the inner chamber 18 and the central portion 56 of the “spin-on” filter.

When the cylindrical upwardly projecting member 48 is not provided communication between the chamber 18 and the central portion 56 of the “spin-on” filter may be provided for by small axial passageways, not shown, radially outwardly of the bore 50 in FIG. 3 and extending axially between the bottom surface of the filter portion 44 and the top surface of the shoulder 46. In this embodiment of the invention, the bore 50 is of course threaded from the sealing surface or shoulder 46 downwardly for reception of a lower end portion of the bolt 24a.

As mentioned, and in either embodiment, the shoulder 46 is preferably radially enlarged as shown to provide for a non-circular peripheral portion which may be engaged by a tool in assembling the adapter with the cover and the bolt 24a. As shown, the periphery of the radially enlarged portion of the shoulder takes on a hex nut configuration at 59.

Lower portion 44 of the adapter 40 is also of cylindrical configuration and is threaded externally for ready engagement with an internally threaded central portion of the “spin-on” filter 58. With the adapter in position on and depending from the cover 10, the bolt 24a extends through the attachment opening in the cover and is threaded into engagement with the upper end portion of the bore 50, the threaded lower end portion 44 of the adapter being exposed downwardly for assembly and disassembly with a “spin-on” automotive filter 58. In assembling the adapter with the cover a tool may be employed at the peripheral hex nut portion 59 of the sealing shoulder 46. As mentioned and in accordance with the presently preferred practice, at least the sealing shoulder or surface is constructed of a relatively soft metal to provide for metal-to-metal sealing with the lower edge portion of the annular cover wall 20. As shown, the entire adapter 40 is constructed of aluminum.

It will be apparent from the foregoing that with a “spin-on” filter in position beneath the cover 10, the outer annular chamber 22 will be in communication with outer annular portion 62 of the “spin-on” filter 58. Thus, conventional small axial openings 64, 64 in the filter receive and pass oil downwardly for filtering in a downward and radially inward path of movement of the oil to the central filter section 56. As is conventional with “spin-on” filters, a built in gasket is provided at 66 and this of course eliminates the replacement of gaskets as mentioned above in connection with a prior art filter replacement procedure.

As suggested above, filter element replacement with a “spin-on” type automotive filter is greatly facilitated and may be accomplished with a minimum of time and effort. As is well known, such filters can be removed at very low torque and perhaps with manually exerted torque alone. Even when a tool may be required for removal, an extremely rapid procedure may result wherein the used filter is “spun” free of the lower portion 44 of the adapter, dropped into a suitable bag or other disposal container, and a new filter is “spun” on to the adapter portion 44 with little or no effort and expenditure of time.

Similarly, and as described above the conversion of a conventional fuel oil or diesel fuel filter is extremely simple, straightforward and may be accomplished with a minimum time expenditure. With the cover 10 remaining “in-line” or in assembly with the line 12 it is merely necessary to retract the bolt 24 and replace the same with a bolt 24a, and then engage the threaded upper end opening in the adapter 40 with the bolt 24a. Tightening of the bolt and the adapter to a desired torque is readily accomplished with the bolt head and the hex nut 59 and the cover and adapter are thereupon fully converted for the reception of a “spin-on” automotive filter.

I claim:

1. An adapter for use with a cover from a conventional fuel oil, diesel oil filter etc. in converting the same to accommodate a standard “spin on” automotive filter, the cover being of the type which has inlet and discharge ports and an inner chamber defined within a depending annular wall which communicates with one of the ports and which opens downwardly, an outer annular chamber around the inner chamber which communicates with the other of said ports and which also opens downwardly, and a small substantially vertical through opening for attachment of the cover to the filter housing; the adapter comprising upper and lower portions respectively for assembly with the cover and with a “spin on” automotive filter, the upper portion of the adapter having at least one opening in communication with said inner chamber when the adapter and cover are assembled, and said upper portion also having a radial sealing surface engageable with a lower end portion of the annular wall in the cover when the adapter and cover are assembled, the adapter lower portion projecting downwardly below the surface and being threaded externally for ready engagement with a standard “spin on” automotive filter, said downwardly projecting portion having a second opening in communication with the aforesaid at least one opening which communicates with said inner chamber in the cover, said second opening also communicating with a central portion of said “spin on” automotive filter when said filter is assembled with said threaded lower portion of the adapter, communication also being established between said outer cover chamber and an annular outer portion of the “spin on” filter disposed about its central portion when the filter is engaged with said threaded lower portion of the adapter; and said adapter upper portion also defining a small upwardly open substantially vertical threaded attachment opening, a threaded attachment element being entered in said cover attachment opening and said threaded attachment opening in the adapter and serving to fix said cover and adapter in assembled relationship.

2. An adapter as set forth in claim 1 wherein the adapter is generally cylindrical and wherein the sealing surface takes the form of an annular sealing shoulder which extends radially outwardly therefrom with a non-circular peripheral surface for engagement by a tool in assembling and disassembling the adapter and cover with the attachment element.

3. An adapter as set forth in claim 2 wherein the periphery of the sealing shoulder takes the form of a conventional hex-nut.

4. An adapter as set forth in claim 2 wherein said upper portion of the adapter projects upwardly beyond said sealing shoulder and into said inner chamber of the cover, and wherein said at least one opening in the upper portion of the adapter is provided in said upwardly projecting portion.

5. An adapter as set forth in claim 4 wherein said upper portion of the adapter has a top surface with said threaded attachment opening disposed therein in vertical alignment with said cover attachment opening for entry of said attachment element in said two openings and for retention of the cover and adapter in assembled relationship.

6. An adapter as set forth in claim 5 wherein said adapter is substantially cylindrical with a central axial through bore, an upper end portion of the bore being threaded for engagement with said attachment element, and a lower portion thereof comprising said second opening, and wherein said upper portion of said adapter is provided with at least one small passageway establishing communication between said bore lower portion and said inner cover chamber when the cover and adapter are assembled.

7. An adapter as set forth in claim 6 wherein two small radial passageways are provided in the form of a transverse through bore in said upper adapter portion to establish communication between said bore and said inner cover chamber.

8. An adapter as set forth in claim 1 wherein said inner cover chamber communicates with the outlet port and said outer annular chamber connects with the inlet port in the cover.

9. An adapter as set forth in claim 1 wherein at least said sealing surface is formed of a soft metal to provide efficient metal-to-metal sealing with said lower end portion of said annular cover wall.

10. An adapter as set forth in claim 9 wherein said adapter is formed of aluminum.
